(19) United States
(12) Patent Application Publication
(10) Pub. No.: US 2026/0117826 A1
(43) Pub. Date: Apr. 30, 2026

(54) MECHANICAL FUSE DEVICE FOR PROTECTING SWITCHING APPARATUS

(71) Applicant: Hitachi Energy Ltd, Zürich (CH)

(72) Inventor: Shashwat CHAUHAN, Ludvika (SE)

(73) Assignee: Hitachi Energy Ltd, Zürich (CH)

(21) Appl. No.: 19/149,542

(22) PCT Filed: Jan. 19, 2023
(86) PCT No.: PCT/EP2023/051235

§ 371 Date: Jul. 20, 2025

(51) Int. Cl. F16D 9/08

(52) U.S. Cl. CPC F16D 9/08

(57) ABSTRACT

A mechanical fuse device for a drive shaft of a switching apparatus is disclosed. The fuse device includes a first connection portion and a second connection portion, and a neck portion connecting the first connection portion and the second connection portion. The drive shaft includes a first part and a second part. The first connection portion is configured to be removably connected to the first part and the second connection portion is configured to be removably connected to the second part thereby connecting the first part and the second part of the drive shaft. The neck portion is a weak link configured to break when being subject to a torque exceeding a predetermined torque value and thereby disconnect the first part and the second part of the drive shaft.

### CROSS REFERENCE TO RELATED APPLICATIONS

This application is a 35 U.S.C. § 371 national stage application of PCT International Application No. PCT/EP2023/051235 filed on Jan. 19, 2023, the disclosure and content of which is incorporated by reference herein in its entirety.

### TECHNICAL FIELD

The present disclosure generally relates to switching apparatuses used for isolating electrical devices from a power line. More particularly, it relates to a mechanical fuse for a drive shaft of a switching apparatus.

### BACKGROUND

In general, a switching apparatus is used for isolating electrical devices from a power line. The switching apparatus includes a disconnector and/or an earthing switch. The disconnector is a mechanical switch adapted for isolating the electrical devices from the power line. The disconnector is typically used in high voltage environment to form a visible disconnecting point to ensure a reliable isolation of the electrical devices from the power line, such that the electrical devices can be operated or maintained safely without a load. The earthing switch/ground switch is operated together with the disconnector to connect the isolated electrical devices to a ground such that a capacitive current or an inductive current remained on the isolated electrical devices can be eliminated and the isolated electrical devices can be operated or maintained more safely.

The disconnector and the earthing switch are equipped with an operational drive mechanism for their operation by means of a motor. In order to make safe operation of the disconnector and the earthing switch, a mechanical interlocking is provided between the disconnector and the earthing switch. If the disconnector or the earthing switch is operated when the mechanical interlock is engaged or under some abnormal working conditions, the operational drive mechanism and/or some components of a power kinematic chain of the disconnector or the earthing switch may be damaged. Damaged components of the power kinematic chain have to be replaced. However, such a replacement is very difficult, and/or very costly or not even possible at all.

FIG. 1 discloses an example arrangement of a drive shaft on an operational drive mechanism in a switching apparatus 200 according to the prior art. The switching apparatus 200 comprises a disconnector (not shown) and an earthing switch 100. The disconnector comprises an operational drive mechanism 92, a drive shaft 82, and a power kinematic chain. Similarly, the earthing switch 100 also comprises an operational drive mechanism 94 with an output shaft, a drive shaft, and a power kinematic chain. The drive shaft is connected to the output shaft of the operational drive mechanism 92/94 of the disconnector or the earthing switch. The drive shaft of the disconnector or the earthing switch 100 couples the operational drive mechanism 92/94 to the power kinematic chain of the disconnector 200 or the earthing switch 100.

In the example arrangement, as depicted in FIG. 1, when the disconnector or the earthing switch operates, resisting torque or operational load can be transferred to the power kinematic chain from the operational drive mechanism 92/94 through the drive shaft.

Whenever the disconnector or the earthing switch 100 are operated under abnormal conditions or under interlocked positions (i.e., when a mechanical interlock provided between the disconnector and the earthing switch is engaged), the operational drive mechanism 92/94 of the disconnector or the earthing switch 100 may experience overload/torque exceeding a predefined torque value. The overload may cause damage to the components of the power kinematic chain and could break the output shaft of the operational drive mechanism 92/94. Thus, a manufacturer has to provide a new operational drive mechanism and/or components of the power kinematic chain as a replacement and until the replacement arrives further activity at a site cannot be resumed. Such a replacement leads to loss to customer as well as a cost of replacement is very high for the manufacturer.

### SUMMARY

Consequently, there is a need for an arrangement that protects the operational drive mechanism and/or the components of the power kinematic chain from any damage and facilitates easy replacement of damaged or broken components that alleviates at least some of the above-cited problems.

It is therefore an object of the present disclosure to provide a mechanical fuse device for a drive shaft of a switching apparatus, to mitigate, alleviate, or eliminate all or at least some of the above-discussed drawbacks of presently known solutions.

This and other objects are achieved by means of a mechanical fuse device, as defined in the appended claims. The term exemplary is in the present context to be understood as serving as an instance, example or illustration.

According to a first aspect of the present disclosure, a mechanical fuse device for a drive shaft of a switching apparatus is provided. The fuse device comprises a first connection portion and a second connection portion, and a neck portion connecting the first connection portion and the second connection portion. The drive shaft comprises a first part and a second part. The first connection portion of the fuse device is configured to be removably connected to the first part and the second connection portion of the fuse device is configured to be removably connected to the second part, thereby connecting the first part and the second part of the drive shaft. The neck portion is a weak link configured to break when being subjected to a torque exceeding a predetermined torque value and thereby disconnect the first part and the second part of the drive shaft.

Thus, the fuse device is removably connected between the first part and the second part of the drive shaft for facilitating transferring of resistive torque to the power kinematic chain from an operational drive mechanism of the switching apparatus. Due to such an arrangement, the fuse device experiences the resistive torque before the power kinematic chain and/or the operational drive mechanism.

Whenever the torque experienced by the fuse device exceeds the predetermined torque value due to any abnormal working of the switching apparatus or an operation of the switching apparatus under an interlocked condition, the fuse device breaks itself and disconnects from the drive shaft. Thus, preventing transferring of excess torque to the power kinematic chain, which further protects the components of the power kinematic chain, disconnector and/or the earthing switch from any damage.

Further, the broken fuse device can be very easily replaced at a site itself with minimum human efforts. Since the fuse device is a single unit, only one component needs to be replaced and a cost of replacement can be reduced compared to replacement of whole operation drive mechanism and/or specialized power kinematic chain components.

In some embodiments, each connection portion comprises at least one attachment point configured to be coupled with the first part and the second part of the drive shaft respectively by means of a fastener. Thus, the fuse device may be easily connected and disconnected/removed from the drive shaft without requiring any high skill.

In some embodiments, the neck portion is hollow and comprises a circumferential wall. In some embodiments, the neck portion is hollow and comprises a circumferential wall and at least one aperture in the circumferential wall.

In some embodiments, the neck portion is solid. In some embodiments, the neck portion is solid and comprises at least one aperture extending through the neck portion.

Thus, the neck portion may be designed in various forms suitable for connecting the first and second connection portions.

In some embodiments, the predetermined torque value at which the neck portion will break depends on a size of the aperture.

Thus, torque/load withstanding capacity of the fuse device may be adjusted by modifying the size of the aperture and a size/dimension of the neck portion. For example, higher a diameter of the neck portion and smaller a diameter of the aperture, the torque withstanding capacity of the fuse device may be higher. The material of the fuse device and/or the heat treatment of the material may also affect the torque/load withstanding capacity of the fuse device. Also, when the neck portion is hollow, the thickness of the circumferential wall may affect the predetermined torque value at which the neck portion will break. Furthermore, the number of apertures in the neck portion will affect the torque/load withstanding capacity of the fuse device. In some examples, the neck portion comprises a plurality of apertures.

In some embodiments, the first and second connection portions and/or the neck portion have a cylindrical and/or a square shape.

In some embodiments, the diameter and/or cross-section of the neck portion is smaller than a diameter and/or cross-section of the first and second connection portions.

Thus, the first and second connection portions and the neck portion may be designed in various shapes according to operational requirements of the fuse device. The shape requirements of the fuse device typically depend on the cross-sectional shape of the drive shaft. Thus, when a drive shaft with a square shaped cross-section is used, the fuse device may be configured with first and second connection portions having a cross-sectional square shape. It is to be understood that the drive shaft may have any polygon cross-section and the connection portions of the fuse device may thus have corresponding polygon cross-sections.

According to a second aspect of the present disclosure, a switching apparatus for an electrical circuit is provided. The switching apparatus comprises at least one drive shaft with a first part and a second part configured for operating the switching apparatus. The switching apparatus further comprises at least one mechanical fuse device (according to the first aspect of the present disclosure), removably connected to the first part and the second part of the drive shaft.

In some embodiments, the first part of the drive shaft is connected to a power kinematic chain.

In some embodiments, the second part of the drive shaft is connected to an operational drive mechanism.

In some embodiments, the at least one fuse device is connected to a drive shaft of a disconnector of the switching apparatus.

In some embodiments, the fuse device is connected to a drive shaft of an earthing switch of the switching apparatus.

Thus, the fuse device may be assembled between the power kinematic chain and the operational drive mechanism of the disconnector or the earthing switch through the first and second parts of the drive shaft. As a result, whenever the disconnector or the earthing switch operates, an entire amount of resistive torque is experienced by the fuse device and then to the power kinematic chain. If the disconnector or the earthing switch is operated under an interlocked condition, the torque exceeds predetermined torque value. In such a condition, the fuse device breaks itself and prevents the operational drive mechanism from experiencing the exceeding torque. Thus, the operational drive mechanism or components of the power kinematic chain are protected from any damage.

In some embodiments, any of the above aspects may additionally have features identical with or corresponding to any of the various features as explained above for any of the other aspects.

Other advantages may be readily apparent to one having skill in the art. Certain embodiments may have some, or all of the recited advantages.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 discloses an example arrangement of a drive shaft on an operational drive mechanism in a switching apparatus according to prior art;

FIG. 2 discloses a switching apparatus in which a drive shaft comprises a mechanical fuse device for the switching apparatus according to some examples;

FIGS. 3A, 3B, and 3C disclose a mechanical fuse device according to some examples; and

FIGS. 4A, 4B, and 4C disclose a drive shaft comprising a mechanical fuse device according to some examples.

### DETAILED DESCRIPTION

Aspects of the present disclosure will be described more fully hereinafter with reference to the accompanying drawings. The apparatus and methods disclosed herein can, however, be realized in many different forms and should not be construed as being limited to the aspects set forth herein. Like numbers in the drawings refer to like elements throughout.

The terminology used herein is for the purpose of describing particular aspects of the disclosure only and is not intended to limit the disclosed subject matter. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Switching apparatus: As used herein, a switching apparatus is referred either to a disconnector or an earthing switch.

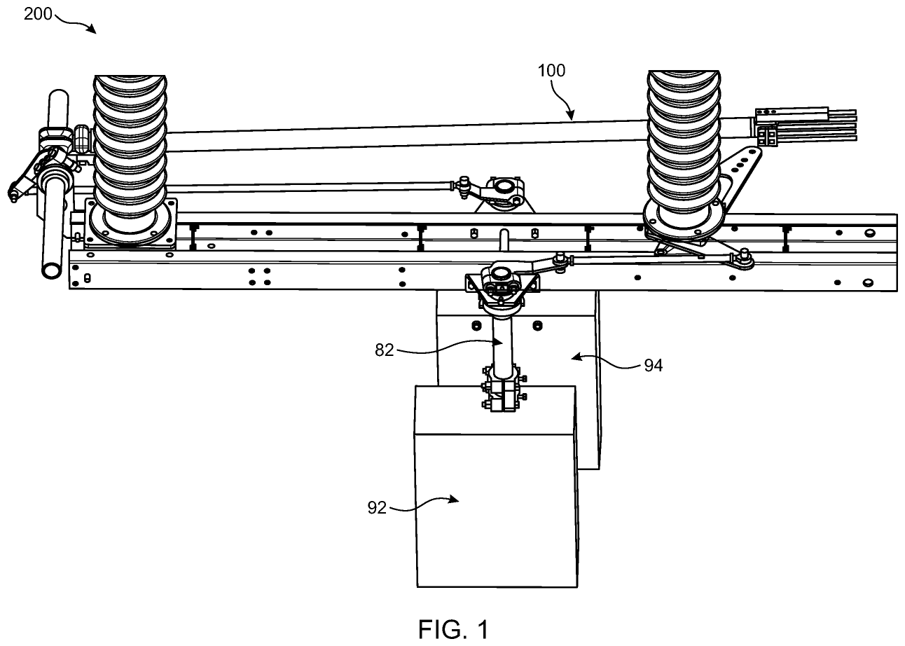

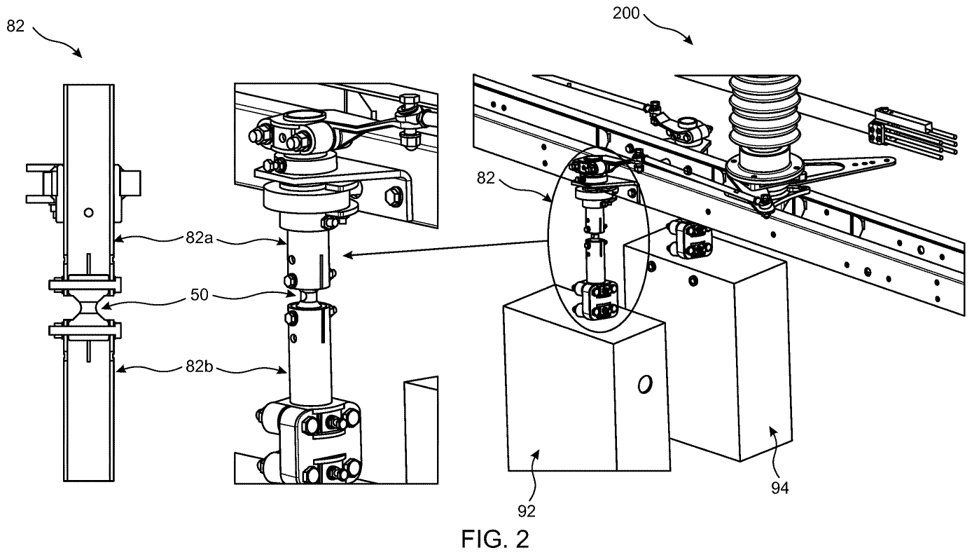

FIG. 2 discloses a switching apparatus 200 comprising a mechanical fuse device 50. The switching apparatus 200 referred herein may comprise a disconnector and/or an earthing switch (depicted in FIG. 1). In some examples, it should be understood that the disconnector and the earthing switch may be arranged together to form the switching apparatus 200. The disconnector (also be referred to as isolator, switchgear, disconnecting switch, or the like) may be a mechanical switch for isolating electrical devices from a power line. Examples of the disconnector may include, but are not limited to, a vertical break disconnector, a horizontal knee break disconnector, a side break disconnector, a centre break disconnector, a double break disconnector, and so on. The earthing switch may be operable to connect the isolated electrical devices to a ground such that a capacitive current or an inductive current remaining on the isolated electrical devices can be eliminated. Thereby, the isolated electrical devices may be operated or maintained more safely.

The switching apparatus 200 (the disconnector or the earthing switch) comprises an operational drive mechanism, a power kinematic chain, and a drive shaft. For simplicity, the disconnector comprising the operational drive mechanism 92, and the drive shaft 82, and the earthing switch comprising the operational drive mechanism 94 are depicted in FIG. 2. The operational drive mechanism 92/94 of the switching apparatus 200 may be configured to operate the disconnector or the earthing switch either by a manual operation or by means of a motor. The power kinematic chain may be connected to a movable contact of the switching apparatus 200. The drive shaft 82 of the disconnector couples the operational drive mechanism 92 to the power kinematic chain of the switching apparatus 200. The drive shaft 82 enables transferring of resisting torque from the power kinematic chain to the operational drive mechanism 92.

In the prior art as disclosed in FIG. 1, the drive shaft is arranged between the operational drive mechanism and the power kinematic chain of the switching apparatus (i.e., the disconnector or the earthing switch). Whenever the switching apparatus is operated under abnormal conditions or under interlocked positions, the operational drive mechanism experiences overload/torque exceeding a predefined torque value. Such an exceeding torque breaks the output shaft of the operational drive mechanism and/or causes damage to the components of the power kinematic chain. Thus, damaged components have to be replaced and until the replacement arrives, further activity at a site cannot be resumed. In addition, such a replacement may be expensive.

Therefore, according to embodiments disclosed herein, a mechanical fuse device 50 is provided for the drive shaft 82 of the switching apparatus 200, which protects one or more components of the switching apparatus 200 from any damage.

As depicted in FIG. 2, the switching apparatus 200 comprises the drive shaft 82 with the mechanical fuse device 50. The drive shaft 82 comprises a first part 82a and a second part 82b configured for operating the switching apparatus 200. The first part 82a is connected to the power kinematic chain. The second part 82b is connected to the operational drive mechanism 92/94.

The mechanical fuse device 50 is configured to be removably connected to the first part 82a and the second part 82b of the drive shaft 82. In some examples, as depicted in FIG. 2, the fuse device 50 may be connected to the drive shaft 82 of the disconnector of the switching apparatus 200. However, it should be understood that the fuse device 50 may also be connected to the drive shaft of the earthing switch of the switching apparatus 200.

With the connection of the fuse device 50 to the first part 82a and the second part 82b of the drive shaft 82, the fuse device 50 is assembled between the power kinematic chain and the operational drive mechanism 92/94 of the switching apparatus 200. Thus, when the switching apparatus 200 operates, the fuse device 50 is subjected to resistive torque before the power kinematic chain experiences the torque. If the switching apparatus 200 is being operated under any abnormal working conditions or under interlocked conditions, the torque may exceed a predetermined torque value. In such a condition, the fuse device 50 breaks itself and disconnects from the drive shaft 82, which prevents any damage to the components of the power kinematic chain and/or output shaft of the operational drive mechanism of the switching apparatus 200.

Various embodiments describing the mechanical fuse device 50 are explained in conjunction with figures in the later parts of the description.

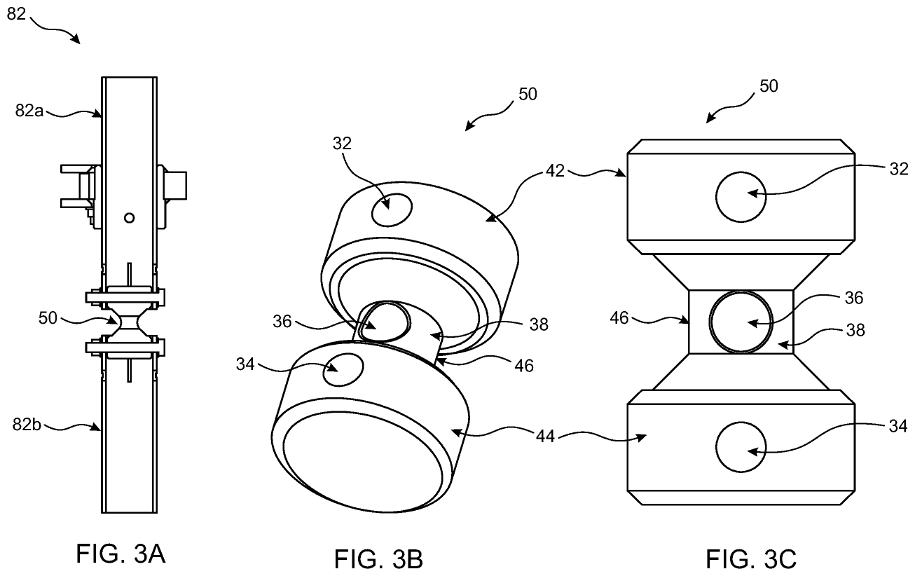

FIGS. 3A, 3B, and 3C disclose the mechanical fuse device 50. The fuse device 50 is provided for the drive shaft 82 of the switching apparatus. The fuse device 50 may protect the switching apparatus from any damage when the switching apparatus is being operated under the abnormal working conditions or the interlocked conditions.

As depicted in FIG. 3A, the fuse device 50 is configured to be removably connected to the first part 82a and the second part 82b of the drive shaft 82. The first part 82a of the drive shaft 82 is connected to the power kinematic chain of the switching apparatus. The second part 82b of the drive shaft 82 is connected to the operational drive mechanism of the switching apparatus. Thus, the fuse device 50 is connected to the power kinematic chain through the first part 82a of the drive shaft 82 and to the operational drive mechanism through the second part 82b of the drive shaft 82. When the switching apparatus operates, the fuse device 50 is subjected to an entire amount of torque before the power kinematic chain experiences the torque.

As depicted in FIGS. 3B and 3C, the fuse device 50 comprises a first connection portion 42, a second connection portion 44, and a neck portion 46. The neck portion 46 connects the first connection portion 42 and the second connection portion 44. In some examples, the first connection portion 42, the second connection portion 44, and the neck portion 46 may have a cylindrical shape, as depicted in FIGS. 3B and 3C. A diameter of the neck portion 46 may be smaller than a diameter of the first and second connection portions 42 and 44.

The first connection portion 42 is configured to be removably connected to the first part 82a of the drive shaft 82. The second connection portion 44 is configured to be removably connected to the second part 82b of the drive shaft 82. Thereby connecting the fuse device 50 between the first part 82a and the second part 82b of the drive shaft. Connecting the fuse device 50 between the first part 82a and the second part 82b of the drive shaft results in an arrangement of the fuse device 50 between the power kinematic chain and the operational drive mechanism 92, 94 of the switching apparatus. When the fuse device 50 is connected between the first part 82a and the second part 82b of the drive shaft, the fuse device 50 facilitates transfer of the torque from the operational drive mechanism to the power kinematic chain to of the switching apparatus 200.

In some embodiments, the first connection portion 42 comprises at least one attachment point 32 configured to be coupled with the first part 82a of the drive shaft 82. The second connection portion 44 comprises at least one attachment point 34 configured to be coupled with the second part 82b of the drive shaft 82. In some examples, the attachment points 32 and 34 may be coupled with the first and second parts 82a, 82b of the drive shaft, respectively by means of a fastener. Thus, the fuse device 50 can be easily connected and disconnected/removed from the drive shaft 82 without requiring any high skill.

The neck portion 46 is a weak link configured to break when being subjected to a torque exceeding a predetermined torque value. In some examples, the torque may exceed the predetermined torque value when the switching apparatus operates under some abnormal working conditions or an interlocked condition. The interlocked condition may be a condition in which a mechanical interlock provided between the disconnector and the earthing switch of the switching apparatus is engaged.

Thus, the neck portion 46 breaks and disconnects the first part 82a and the second part 82b of the drive shaft when the switching apparatus 200 operates under some abnormal working conditions or the interlocked condition. The fuse device 50 breaking prevents transferring of exceeding torque from the operational drive mechanism to the power kinematic chain, which further protects the components of the power kinematic chain from any damage.

In addition, replacement of the broken fuse device 50 may be very easy. Such a replacement may be performed easily with minimal human efforts.

In some embodiments, as depicted in FIGS. 3B and 3C, the neck portion 46 may be hollow and comprises a circumferential wall 38 and at least one aperture 36 in the wall 38. The predetermined torque at which the neck portion 46 breaks (may be referred to as a torque/load withstanding capacity of the fuse device 50) may depend on a size of the aperture 36 and/or diameter of the neck portion 46. In some examples, the torque/load withstanding capacity of the fuse device 50 may be adjusted by modifying the size of the aperture 36, and a diameter of the neck portion 46, as well as by selecting higher strength material like alloy steel for the fuse device 50. For example, higher the diameter of the neck portion 46 and smaller the diameter of the aperture 36, higher will be the torque withstanding capacity of the fuse device 50.

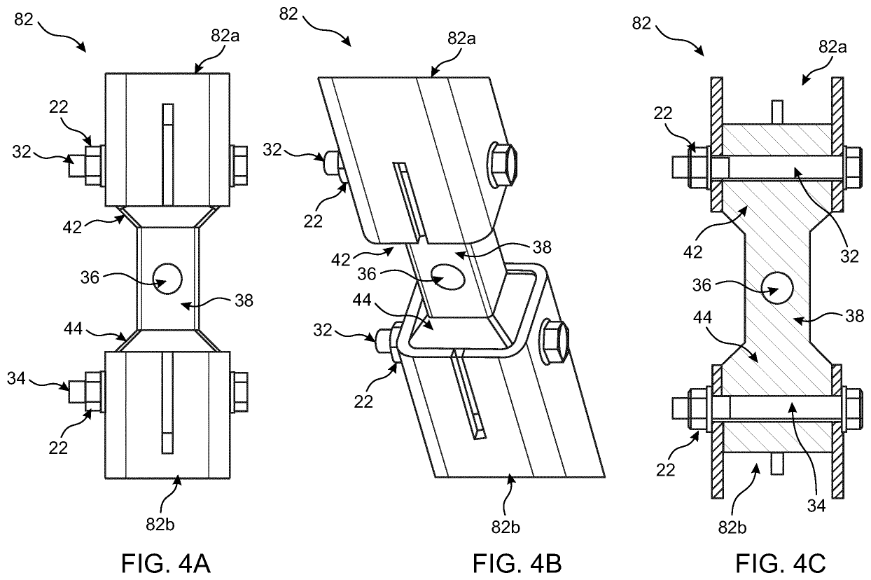

FIGS. 4A, 4B, and 4C disclose the drive shaft 82 of the switching apparatus comprising the mechanical fuse device 50. The fuse device 50 comprises the first connection portion 42, the second connection portion 44, and the neck portion 46. In some examples, as depicted in FIGS. 4A, 4B, and 4C, the first connection portion 42, the second connection portion 44, and the neck portion 46 can have a square shaped cross-section. A cross-section of the neck portion 46 may be smaller than a cross-section of the first and second connection portions 42 and 44.

The first and second connection portions 42 and 44 are configured to be removably connected to the first and second parts 82a and 82b of the drive shaft 82, respectively. Each of the first and second connection portions 42 and 44 can have at least one attachment point 32 and 34 and configured to be coupled with the first part 82a and the second part 82b of the drive shaft 82, respectively by means of a fastener 22.

The neck portion 46 is a weak link connecting the first connection portion 42 and the second connection portion 44. The neck portion 46 is configured to break when being subjected to a torque exceeding a predetermined torque value. Thereby, disconnecting the fuse device 50 from the first part 82a and the second part 82b of the drive shaft.

In some examples, as depicted in FIGS. 4A, 4B, and 4C, the neck portion 46 may be solid and comprises at least one aperture 36 in the circumferential wall 38 extending through the neck portion 46. The predetermined torque at which the neck portion 46 will break (may be referred to as a torque/load withstanding capacity of the fuse device 50) may depend on a size of the aperture 36.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

1. A mechanical fuse device for a drive shaft of a switching apparatus, the fuse device comprising:
a first connection portion and a second connection portion; and
a neck portion connecting the first connection portion and the second connection portion,
wherein the drive shaft comprises a first part and a second part and the first connection portion is configured to be removably connected to the first part and the second connection portion is configured to be removably connected to the second part thereby connecting the first part and the second part of the drive shaft, wherein the neck portion is a weak link configured to break when being subject to a torque exceeding a predetermined torque value and thereby disconnect the first part and the second part of the drive shaft.

2. The mechanical fuse device according to claim 1, wherein each connection portion comprises at least one attachment point configured to be coupled with the first part and second part of the drive shaft respectively by means of a fastener.

3. The mechanical fuse device according to claim 1, wherein the neck portion is hollow and comprises a circumferential wall and at least one aperture in the wall.

4. The mechanical fuse device according to claim 1, wherein the neck portion is solid and comprises at least one aperture extending through the neck portion.

5. The mechanical fuse device according to claim 3, wherein the predetermined torque value at which the neck portion will break depends on a size of the aperture.

6. The mechanical fuse device according to claim 1, wherein the first and second connection portions and/or the neck portion have a cylindrical and/or square and/or polygon cross-sectional shape.

7. The mechanical fuse device according to claim 6, wherein a diameter and/or cross-section of the neck portion is smaller than a diameter and/or cross-section of the first and second connection portions.

8. A switching apparatus for an electrical circuit, the switching apparatus comprising:
at least one drive shaft with a first part and a second part, configured for operating the switching apparatus; and
at least one mechanical fuse device according to claim 1, removably connected to the first part and the second part of the drive shaft.

9. The switching apparatus according to claim 8, wherein the first part of the drive shaft is connected to a power kinematic chain.

10. The switching apparatus according to claim 8, wherein the second part of the drive shaft is connected to an operational drive mechanism.

11. The switching apparatus according to claim 8, wherein the at least one fuse device is connected to a drive shaft of a disconnector of the switching apparatus.

12. The switching apparatus according to claim 8, wherein the fuse device is connected to a drive shaft of an earthing switch of the switching apparatus.
